(19) United States
(12) Patent Application Publication
(10) Pub. No.: US 2021/0342777 A1
(43) Pub. Date: Nov. 4, 2021

(54) METHOD AND APPARATUS FOR SAFE AND TIMELY DELIVERY OF A PACKAGE

(71) Applicant: Antonio G. Rasmus, Elmont, NY (US)

(72) Inventor: Antonio G. Rasmus, Elmont, NY (US)

(21) Appl. No.: 17/306,741

(22) Filed: May 3, 2021

Related U.S. Application Data
(60) Provisional application No. 63/019,426, filed on May 3, 2020.

(51) Int. Cl. G06Q 10/08; G06Q 20/10; H04W 4/021; H04W 4/029

(52) U.S. Cl. CPC G06Q 10/0833; G06Q 10/08355; H04W 4/029; G06Q 20/102; H04W 4/021; G06Q 10/08345

(57) ABSTRACT

A system that coordinates delivery of a package from a first location to a second location is described. The system includes a delivery coordination server and a first device located at a first location, a second device located at a second location, and a third device connected via a communication network. A first arrival notification associated with a package is received from a first device. A second arrival notification regarding an arrival of the package at the first location is sent to a second device. A pick-up notification is received from the second device indicating an intended time of pick-up of the package from the first location. Navigation data is sent to the second device at the intended time of pick-up. A delivery confirmation notification is received from the first device and/or the second device indicating that the package has been delivered to or picked up from the first location.

### CROSS-REFERENCE TO RELATED APPLICATIONS SECTION

This application is a U.S. Non-Provisional Patent Application that claims priority to U.S. Provisional Patent Application Ser. No. 63/019,426 filed on May 3, 2020, the entire contents of which are hereby incorporated by reference in their entirety.

### FIELD OF THE EMBODIMENTS

Embodiments of the present invention generally relate to a method and apparatus for package logistics, and more specifically, to the safe and timely delivery of a package.

### BACKGROUND OF THE EMBODIMENTS

While package deliveries have always enabled a large part of retail economy, with the advent of online shopping, package delivery has become ubiquitous in today's commerce and lifestyle. In many cases, packages are left by the door, driveway and the like, either because the package addressee is not available or because it is more efficient for the package delivery companies to do so. In general, packages that are left at the address, rather than handed over to the addressee, suffer from several problems, such as theft, damage, for example, due to miscreants, animals, insects, elements of nature, and the like. In cases where the package must be hand delivered, the addressee or another adult is typically required to be present, which presents an inconvenience for the addressee to be physically at the delivery address during the window of delivery offered by the delivery company. In several cases, the delivery company is delayed, and in such cases, the delivery needs to be rescheduled, which presents additional undesirable issues, expense and waste of time for both the customer and the delivery companies. Therefore, there exists a need for a method and apparatus for safe and timely delivery of packages.

### SUMMARY OF THE EMBODIMENTS

The present invention provides a method and an apparatus for the safe and timely delivery of a package, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

A first embodiment of the present invention describes a method executed by a system to coordinate delivery of a package from a first location to a second location. The system includes a delivery coordination server and a first device and a second device connected via a communication network. The method includes numerous process steps, such as: receiving a first arrival notification associated with a package from a first device and sending a second arrival notification regarding an arrival of the package at the first location to a second device. The first device is located at a first location and the second device is located at a second location remote from the first location of the first device. The first location and the second location are in a predefined geographical region.

The method also includes: receiving a pick-up notification from the second device indicating an intended time of pick-up of the package from the first location and sending navigation data to the second device at the intended time of pick-up. In examples, the navigation data comprises instructions from a current location of the second device to the first location.

The method also includes: receiving a delivery confirmation notification from the first device and/or the second device indicating that the package has been delivered to or picked up from the first location, and facilitating a payment from a second party associated with the second device to a first party associated with the first device. The delivery confirmation notification comprises proof of delivery from the first party and/or proof of pickup from the second party. The proof of delivery and the proof of pickup may include: a photograph, a video, audio, a biometric identification (e.g., a fingerprint scan, an eye scan, and a face scan, etc.), and/or a textual notification.

In some examples, the method further includes: sending a notification to the first device that the intended time of pickup is approaching, that the second device has accessed the navigation data, and/or that the second device has started an approach towards the first location. In some examples, the method optionally includes: receiving a request from the second device for assisted delivery of the package from the first location to the second location, where the request comprises an offer price representing an amount of money the second party offers for a pickup of the package. The method may also optionally include: sending a pick-up confirmation notification to the second device based on a corresponding notification of pick-up of the package from the first device and/or a third device and sending a delivery confirmation to the second device based upon receiving notification of delivery by the first device and/or the third device of the package to the second location. The pick-up confirmation notification comprises an acceptance of the amount of money the second party offers for the pickup of the package or a bid amount that the first party and/or the third party wish to charge for assisting with the delivery of the package.

A second embodiment of the present invention describes a system. The system coordinates a delivery of a package from a first location to a second location. The system includes: a delivery coordination server, a communication network, a first device associated with a first party and a first location, a second device associated with a second party and a second location, and a third device associated with a third party. The first location is remote from the second location. Further, the first location and the second location are in a predefined geographical region. The first device, the second device, and the third device are connected via the communication network.

In examples, the delivery coordination server comprises a notification module configured to receive and send notifications from and to the first device, the second device, and/or the third device. In other examples, the delivery coordination server comprises a navigation module configured to, based on any two locations, generate navigation instructions between the two locations. In further examples, the delivery coordination server comprises a payment module configured to communicate with an external electronic wallet service remote to the delivery coordination server to facilitate a payment between the first party, the second party, and/or the third party.

The delivery coordination server may also include a delivery module configured to coordinate and reconcile receipt of the package at the first location, pick up of the package from the first location, and delivery of the package at the second location. In other examples, the delivery coordination server comprises a safety feature allowing for the first party, the second party, and/or the third party to directly engage law enforcement.

It is an object of the present invention to provide a method and apparatus for package logistics, and more specifically, to the safe and timely delivery of a package.

It is an object of the present invention to provide a system by which packages may be delivered and dropped off at specified locations to avoid theft of said package.

It is an object of the present invention to provide a system by which packages may be delivered and dropped off at specified locations, while complying with safe handling procedures and processes to protect against the spread of COVID-19 and other similar illnesses and diseases.

### BRIEF DESCRIPTION OF THE DRAWINGS

FIG. 1 depicts a schematic of an apparatus for safe and timely delivery of a package, according to an embodiment of the present invention.

FIG. 2 depicts a flow diagram of a method for safe and timely delivery of a package, for example, performed by the apparatus of FIG. 1, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Embodiments of the present invention relate to a method and an apparatus for safe and timely delivery of a package. A first party acts as an intermediary for safe receipt of a package meant for a second party, and the package is delivered to a predetermined first location in a given neighborhood or geographical region. The first location is managed by the first party (intermediary), and the second party either resides proximate to the first location, for example, in the neighborhood or the geographical region, or otherwise requires delivery of the package at the first location. Upon receipt of the package at the first location, the first party, using a first device, sends a notification of receipt, which is conveyed to the second party (addressee of the package) advising that the package has been received at the first location. In response, the second party and the first party may exchange notification(s) to schedule or reschedule a time for pick-up of the package by the second party from the first location. With or without scheduling, the second party picks up the package, and either or both of the first party or the second party may capture proof of delivery (or hand over) of the package to the second party, for example, using the first or the second device, respectively.

The second party may additionally wish to have the package delivered to a defined location, such as a residence or another desired second location. In some examples, the other desired second location is a stand-alone destination that is proximate the package recipients house. The second party initiates a request for such a delivery to the second location, which is communicated to at least one third party (a delivery person) on a third device. The third party picks up the package meant for the second party from the first location, and hand delivers the package to the second party at the second location. A proof of pickup of the package from the first location is captured by either or both the first party or the third party using the first or the third device, respectively. A proof of delivery of the package to the second location or the second party is captured by either or both the second party or the third party using the second or the third device, respectively.

The second party may also authorize a payment to the first party or the third party, as appropriate, using the second device. A server, communicably coupled to the first device, the second device, and the third device exchanges messages between the three devices, provides navigation data, proof of pick up or delivery, enables monetary transactions between devices, including performing the functions of an electronic wallet for one or more of the first, second or third parties. In some embodiments, the server is additionally configured to, in communication with one or more of a device installed at the first location, a device installed on the second location, a device installed on the person or a vehicle of the third party, the first device (associated with the first party), the second device (associated with the second party), or the third device (associated with the third device), send notifications to any of the devices or parties, track locations between any two parties or devices, compute navigation route between any two parties, devices or locations, record multimedia or location data for any party, device or location, among other similar actions. The devices installed at the first or the second locations or the device installed on the person or vehicle of the third party, may include, without limitation, one or more of a multimedia capture device (e.g. a camera), a location capture device (e.g. GPS), sensors for detecting one or more of proximity, contact, change in weight, temperature, water, sound, specific chemicals, biometrics, among others. Further, the devices may be Internet of Things (IoT) devices.

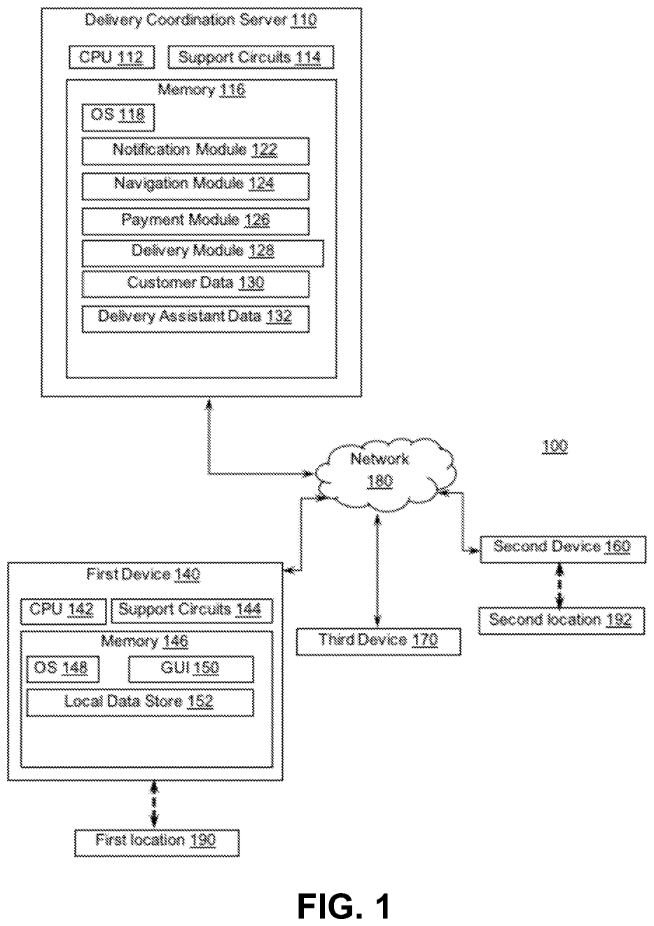

FIG. 1 is a schematic diagram of a system 100 that coordinates the delivery of the package from a first location 190 to a second location 192, according to an embodiment of the invention. The system 100 comprises a delivery coordination server (DCS) 110, a first device 140, a second device 160, and a third device 170, where each of the first device 140, the second device 160, and the third device 170 are connected via a communication network 180. Each of the first device 140, the second device 160, and the third device 170 may be a computer, a laptop computer, a smartphone, and/or a tablet, among other examples not explicitly listed herein.

The network 180 comprises the Internet, or a wide area network (WAN), a mesh network, or a combination thereof, and may include one or more such networks, spanning the various devices as illustrated in FIG. 1. All the components of the system 100 are connected to the network 180 or to each other as illustrated in FIG. 1, using known methods and components.

Each of the first device 140, the second device 160, and the third device 170 are associated with a corresponding person, namely, a first party (intermediary), a second party (addressee), and a third party (delivery person), respectively. Typically, each of the parties, and the corresponding devices are remote to each other. The first device 140 is associated with a first location 190, and the second device 160 is associated with a second location 192, which is remote to the first location 190. Both the first location 190 and the second location 192 are typically in a predefined geographical region, such as a neighborhood or a residential community, for example. The DCS 110 is remote to the first device 140, the second device 160, and the third device 170 or to the first location 190 and the second location 192.

The DCS 110 may be a general-purpose computer or other electronic device that is programmed to perform functions related to embodiments of the present invention. The DCS 110 comprises a CPU 112, support circuits 114, and a memory 116 containing instructions and algorithms. The CPU 112 may be any commercially available processor, microprocessor, microcontroller, and the like. The support circuits 114 comprise well-known circuits that provide functionality to the CPU such as a user interface, clock circuits, network communications, cache, power supplies, I/O circuits and the like. Alternative embodiments may use control algorithms on a custom Application Specific Integrated Circuit (ASIC) to provide the functionality provided by the any combination of the CPU 112, the support circuits 114 and the memory 116. In some embodiments, the user interface comprises a keypad, electronic buttons, speaker, touchscreen, display, or other user interaction mechanism.

The memory 116 may be any form of digital storage used for storing data and executable software. Such memory 116 includes, but is not limited to, random access memory, read only memory, disk storage, optical storage, and the like. The memory 116 stores computer readable instructions corresponding to an operating system (OS) 118, a notification module 122, a navigation module 124, a payment module 126, a delivery module 128, customer data 130, and delivery assistant data 132. It should be appreciated that in examples, the modules may be engines, applications, software programs, services, or software platforms configured to be executable by the DCS 110.

The notification module 122 of the DCS 110 is configured to receive and send notifications from and to the first device 140, the second device 160, and/or the third device 170, at the first or second locations 190, 192, or device(s) on the person or the vehicle of the third party.

The navigation module 124 of the DCS 110 is configured to, based on any two locations, for example, location of any two devices or locations provided as an input by any of the first, second or third party, generate navigation instructions between such two locations, including a route map, expected time or arrival, among others. In some embodiments, the navigation module 124 also generates notification(s) corresponding to a current location of the any party or device, and sends such notifications to the notification module 122 to further notify a party or a device of such notification. For example, the navigation module 124 may provide navigation instructions to the second device 160 for navigation from the second location 192 or a current location of the second device 160, to the first location 190. The navigation module 124 may also provide the current location data of the second device 160, which may be used to display the location of the second device 160 on a map in the graphical user interface (GUI) on the first and/or the second devices, for example, the GUI 150. It should be appreciated that the navigation module 124 provides a real-time and live-tracking/GPS feature.

The payment module 126 of the DCS 110 is configured to perform functions of electronic wallets as generally known in the art, and at least includes a representative amount of money available in corresponding wallets for each of the first, second and third parties, and enable a monetary transaction between any two or three of the parties. As described herein, the electronic wallet or “e-wallet” is an electronic device, online service, or software program that allows one party to make electronic transactions with another party bartering digital currency units for goods and services. In some embodiments, the payment module 126 communicates with an external electronic wallet service (not shown) remote to the DCS 110.

The delivery module 128 of the DCS 110 is configured to coordinate and reconcile receipt of the package at the first location 190, pick up of the package from the first location 190, and delivery of the package at the second location 192. The delivery module 128 receives delivery confirmation notification data comprising proof of delivery or proof of pick up, for example, one or more of a photograph, a video, a textual identification number, audio, biometrics (e.g. fingerprint scan, eye scan, face scan, etc.), location and associates the data with a pickup event or a delivery event. The delivery module 128 of the DCS 110 also allows a party to pre-set or pre-schedule the timing of a pick up or a drop off of the package.

The customer data 130 of the DCS 110 includes information about a customer, for example, the second party who is the addressee of the package, and may include, without limitation, one or more of a name, an assigned identifier, one or addresses for delivery, payment authorization, subscription information, among others.

The delivery assistant data 132 of the DCS 110 includes information about the first party (the intermediary) and the third party (the delivery person) and may include, without limitation, one or more of a name, an assigned identifier, one or addresses for pickup and/or delivery, account for payment, among others.

Moreover, the DCS 110 also provides a safety feature or module allowing for a party to directly engage law enforcement, a tip module allowing for a party to leave a tip for the service, and/or a review module allowing a party to leave graphical or textual review/feedback based on their experience using the system 100. In some examples, the textual review/feedback may be present as a number (e.g., a rating of 5), a fraction (e.g., a 6/10 rating), a graphic (e.g., three stars out of five stars), etc. The means of displaying the textual review/feedback is non-limiting.

As briefly described, the first device 140 is a computer, such as a personal computer (PC), a laptop, a tablet, a smartphone, and the like, and comprises a CPU 142, support circuits 144 and a memory 146. The CPU 142 may be any commercially available processor, microprocessor, microcontroller, and the like. The support circuits 144 comprise well-known circuits that provide functionality to the CPU such as a user interface, clock circuits, network communications, cache, power supplies, I/O circuits, and the like. The I/O circuits include a display, for example, various standard or touch-based displays, such as computer monitors, or touchscreens for smart devices (e.g. smartphones, smart watches) as generally known in the art. In some embodiments, the user interface comprises a keypad, electronic buttons, speaker, touchscreen, display, or other user interaction mechanism. In some embodiments, the support circuits 144 include one or more of a multimedia capture device (e.g., a camera, a microphone), a location capture device (a GPS sensor), a fingerprint sensor, a biometric sensor, or other sensors. The memory 146 is any form of digital storage used for storing data and executable software. Such memory includes, but is not limited to, random access memory, read only memory, disk storage, optical storage, and the like. The memory 146 stores computer readable instructions corresponding to an operating system (OS) 148, and a graphical user interface (GUI) 150, which is displayed on the display, and a local data store 152.

The GUI 150 is installed on the first device 140, or a rendered via a browser on the first device 140. In some embodiments, the GUI is resident on the DCS 110, but is rendered on the first device 140 via the browser on the first device 140. The second device 160 and the third device 170 are similar in components and/or functionality to the first device 140. In examples, each of the first device 140, the second device 160, and the third device 170 may comprise a capability to allow the user to download or electronically send a mailing label associated with the package.

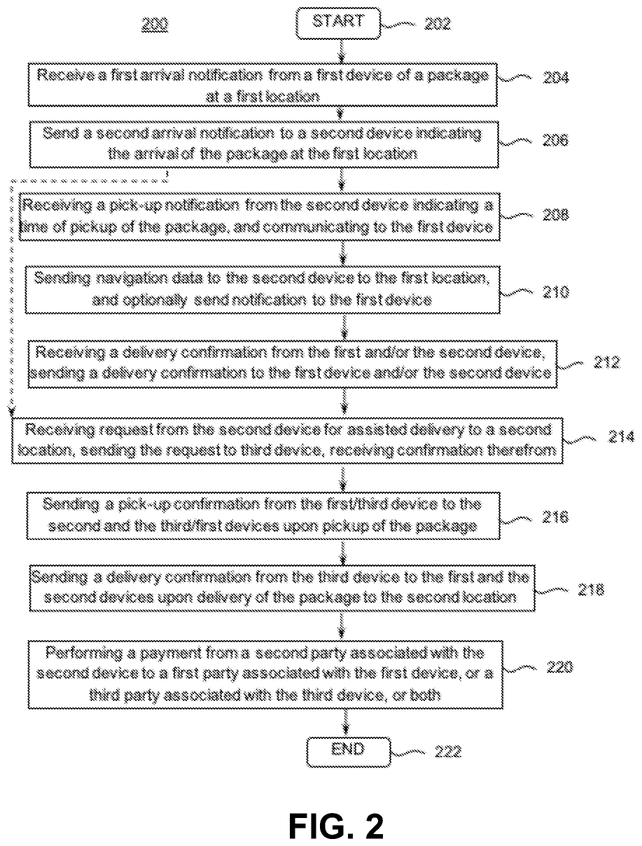

FIG. 2 depicts a flow diagram of a method 200 for safe and timely delivery of a package, for example, performed by the system 100 of FIG. 1, according to an embodiment of the present invention. In some embodiments, the method 200 is performed by the DCS 110.

The method 200 starts at step 202, and proceeds to step 204, at which the method 200 receives a first arrival notification from a first device, for example, the first device 140 of a package at a first location, for example the first location 190. The package may be delivered by any of the known delivery mechanisms and the package is addressed to the second party (addressee).

At step 206, the method 200 sends a second arrival notification to a second device, for example, the second device 160 indicating the arrival of the package at the first location 190, based on receiving the first arrival notification.

At step 208, the method 200 receives a pick-up notification from the second device indicating an intended time of pick-up of the package from the first location 190.

At step 210, the method 200 sends navigation data to the second device at the intended time of pick-up, the navigation data comprising navigation instructions from a current location of the second device 160 to the first location 190. In some embodiments, the navigation instructions default to navigation data from the second location 192 to the first location 190 based on a preference selected at the second device 160. Further, the method 200 may optionally send a notification to the first device that the intended time of pickup is approaching, or that the second device has accessed the navigation data or started approach towards the first location 190.

At step 212, the method 200 receives a delivery confirmation notification from either the first device, or the second device or both that the package has been delivered to or picked up by the second party from the first location. The delivery confirmation notification comprises proof of delivery (from the first party) and/or proof of pick up (from the second party), for example, one or more of a photograph, a video, an audio, biometrics (e.g. fingerprint, eye scan, face scan), location and associates the data with a pickup event (for the second party) or a delivery event (for the first party). The proof of delivery notification received from the first party (device) is sent to the second party (device) for confirmation, and upon receiving a confirmation notification, it is determined that the delivery/pickup of the package is successfully completed. As an alternative or supplement, a pickup confirmation notification is received from the second party (device) and sent to the first party (device) for confirmation, and upon receiving a confirmation notification, it is determined that the delivery/pickup of the package is successfully completed. Further such confirmations serve as proof for any later references.

At step 214, the method 200 receives request from the second party (device) for assisted delivery of the package from the first location 190, to a second location, for example the second location 192. The method 200 sends the request to at least one third party (device) and receives a confirmation from the third party that the third party shall assist in the delivery of the package from the first location 190 to the second location 192. In some embodiments, the request by the second party may include an offer price representing the amount of money the second party offers for pickup of the package, and confirmation by the third party indicates acceptance of such amount, or in response to or independently, a bid amount that the third party wishes to charge for assisting with the delivery of the package. In some embodiments, information about the package (weight, dimensions etc.) are made available (e.g. by the delivery company, the second party, the first party after receiving the package) and provided to the third party. If the third party sends a bid, a confirmation from the second party is received before the method 200 proceeds to step 216. In some embodiments, the second and/or the third parties may revise their offers or bids, respectively.

At step 216, the method 200 sends a pick-up confirmation notification to the second device, based on corresponding notification of pick-up of the package from the first and/or the third device.

At step 218, the method 200 sends a delivery confirmation to the first and the second devices, based upon receiving notification of delivery by the third device of the package to the second location. In some embodiments, the delivery confirmation notification may be based on a notification received from the second party (device), and is sent to the first and third parties (and devices).

At step 220, the method 200 performs payment from the second party to the first party or the third party, or both. The method 200 proceeds to step 222 at which the method 200 ends.

Some of the steps above are optional, for example, steps 214-218, step 200. Various functionalities of the components of the DCS 100 and the first, second and third devices 140, 160 or 170 in the method 200 are apparent. Additionally, devices installed at the first or the second locations or the device installed on the person or vehicle of the third party, are not shown, and may include, without limitation, one or more of a multimedia capture device (e.g. a camera), a location capture device (e.g. GPS), sensors for detecting one or more of proximity, contact, change in weight, temperature, water, sound, specific chemicals, biometrics, among others. Further, the devices may be Internet of Things (IoT) devices. Such devices are capable of sending additional notifications and data to the DCS 110 for further tracking of the package or the first, second or third parties and corresponding devices.

Techniques illustrated by various embodiments discussed herein make software development for a group of controller-based devices quick and easy for a user, by avoiding the need to learn complex controller programming language, and track connections and defined communication protocols. In some embodiments, the DCS 110 is implemented as a service (not shown) that provides various functionalities required by the first device 140, the second device 160 and the third device 170 via a corresponding application (or app) installed on each of such first, second or third devices. In some embodiments, the app installed on each of the first, second or third devices is different, that is, configured according to usage for the corresponding first, second or third party, respectively.

The methods described herein may be implemented in software, hardware, or a combination thereof, in different embodiments. The methods may be embodied in computer instructions stored in a non-transitory computer readable medium, and executed by one or more processors to perform the methods. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as described above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein. When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a system to coordinate delivery of a package from a first location to a second location, the system comprising a delivery coordination server and a first device and a second device connected via a communication network, the method comprising:
receiving a first arrival notification associated with a package from a first device, wherein the first device is located at a first location;
sending a second arrival notification regarding an arrival of the package at the first location to a second device, wherein the second device is located at a second location remote from the first location of the first device;
receiving a pick-up notification from the second device indicating an intended time of pick-up of the package from the first location;
sending navigation data to the second device at the intended time of pick-up;
receiving a delivery confirmation notification from the first device and/or the second device indicating that the package has been delivered to or picked up from the first location; and
facilitating a payment from a second party associated with the second device to a first party associated with the first device.

2. The method of claim 1, wherein the first location and the second location are in a predefined geographical region.

3. The method of claim 1, wherein the navigation data comprises instructions from a current location of the second device to the first location.

4. The method of claim 1, further comprising:
sending a notification to the first device that the intended time of pickup is approaching, that the second device has accessed the navigation data, and/or that the second device has started an approach towards the first location.

5. The method of claim 1, wherein the delivery confirmation notification comprises proof of delivery from the first party and/or proof of pickup from the second party.

6. The method of claim 5, wherein each of the proof of delivery and the proof of pickup are selected from the group consisting of: a photograph, a video, audio, a biometric identification, and a textual notification.

7. The method of claim 6, wherein the biometric identification is selected from the group consisting of: a fingerprint scan, an eye scan, and a face scan.

8. The method of claim 1, further comprising:
receiving a request from the second device for assisted delivery of the package from the first location to the second location.

9. The method of claim 8, wherein the request comprises an offer price representing an amount of money the second party offers for a pickup of the package.

10. The method of claim 8, further comprising:
sending a pick-up confirmation notification to the second device based on a corresponding notification of pick-up of the package from the first device and/or a third device; and
sending a delivery confirmation to the second device based upon receiving notification of delivery by the first device and/or the third device of the package to the second location.

11. The method of claim 10, wherein the pick-up confirmation notification comprises an acceptance of the amount of money the second party offers for the pickup of the package or a bid amount that the first party and/or the third party wish to charge for assisting with the delivery of the package.

12. A system that coordinates a delivery of a package from a first location to a second location, the system comprising:
a delivery coordination server;
a communication network;
a first device associated with a first party and a first location;
a second device associated with a second party and a second location, wherein the first location is remote from the second location; and
a third device associated with a third party, wherein the first device, the second device, and the third device are connected via the communication network.

13. The system of claim 12, wherein the first location and the second location are in a predefined geographical region.

14. The system of claim 12, wherein the delivery coordination server comprises a notification module configured to receive and send notifications from and to the first device, the second device, and/or the third device.

15. The system of claim 12, wherein the delivery coordination server comprises a navigation module configured to, based on any two locations, generate navigation instructions between the two locations.

16. The system of claim 12, wherein the delivery coordination server comprises a payment module configured to communicate with an external electronic wallet service remote to the delivery coordination server to facilitate a payment between the first party, the second party, and/or the third party.

17. The system of claim 12, wherein the delivery coordination server comprises a delivery module configured to coordinate and reconcile receipt of the package at the first location, pick up of the package from the first location, and delivery of the package at the second location.

18. The system of claim 12, wherein the delivery coordination server comprises a safety feature allowing for the first party, the second party, and/or the third party to directly engage law enforcement.
